(19) United States
(12) Patent Application Publication
(10) Pub. No.: US 2007/0289574 A1
(43) Pub. Date: Dec. 20, 2007

(54) AIR PRESSURE BOOST ASSIST

(76) Inventors: Ted Stewart, Ponte Vedra Beach, FL (US); James Napier, Atlantic Beach, FL (US)

Correspondence Address: Steven L. Schmid, 1824 Hickory Trace Dr., Fleming Island, FL, 32003, US

(21) Appl. No.: 11/685,473

(22) Filed: Mar. 13, 2007

Related U.S. Application Data
(60) Provisional application No. 60/786,803, filed on Mar. 28, 2006.

(51) Int. Cl. F02D 9/00

(52) U.S. Cl. 123/402

(57) ABSTRACT

Disclosed is an electronic module designed to use the locomotive engine's speed sensors to detect such changes in engine speed (rpm), as required by the locomotive operator moving the throttle notch handle. Once a speed change is detected, the module commands an air valve on each of the locomotive's main air reservoir tanks, (designed to handle the normal operating main reservoir air pressure), to open and allow them to discharge into the engine's intake manifolds located on both sides of the diesel engine.

### CROSS-REFERENCE TO RELATED APPLICATION

This application claims priority to U.S. Provisional Patent Application Ser. No. 60/786,803 filed Mar. 28, 2006, the contents of which are hereby incorporated in their entirety.

### ABSTRACT

The prevent invention provides an intake manifold air pressure boost using a locomotive's main reservoir air supply during diesel engine speed and load transition periods during throttle notch changes.

### BACKGROUND

GE locomotive diesel engines are susceptible to short period bursts of high visible smoke levels during throttle notch changes, (speed and load fluctuations).

During these throttle notch changes, the loading demands on the engine are such that the combustion fuel/air ratio is extremely rich, thus creating the situation where the fuel is inefficiently burned resulting in high levels of visible smoke from the locomotive's exhaust muffler or stack.

### DRAWING

FIG. 1 is a block flow diagram of the present method and apparatus for detecting a speed change and signaling an air valve to discharge air into an engine's intake manifold.

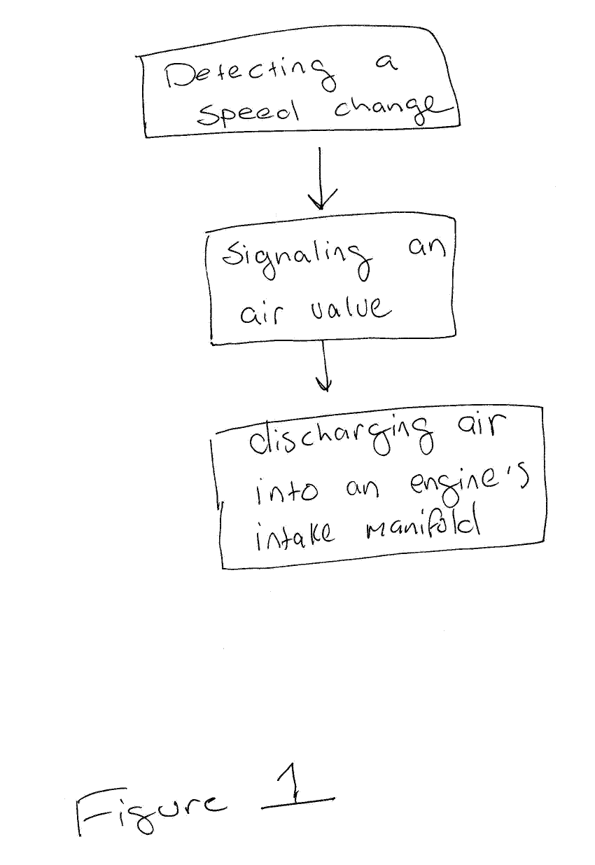

### DESCRIPTION

In order to offset the condition described above, the locomotive's main reservoir air supply is used to increase the intake manifold air supply and pressure to the engine's individual cylinders to help re-balance the combustion fuel/air ratio, thus reducing the smoke levels.

The invention includes an electronic module designed to use the locomotive engine's speed sensors to detect such changes in engine speed (rpm), as required by the locomotive operator moving the throttle notch handle. Once a speed change is detected, the module commands an air valve on each of the locomotive's main air reservoir tanks, (designed to handle the normal operating main reservoir air pressure), to open and allow them to discharge into the engine's intake manifolds located on both sides of the diesel engine.

The additional air pressure boost from the main reservoir tanks is needed for only a short amount of time, which will be confirmed during testing. Once the testing is completed, the electronic control module would then be programmed to open and close the air supply valve as needed.

Some conditions may require different time spans of increased boost due to the extent and level of the unacceptable smoke levels. Therefore, the module must be programmed to determine when these conditions will occur, based on the engine's speed or on the locomotive's trainline throttle position.

What is claimed is:

1. A air pressure boost assist device comprising:
an electronic module for use with a locomotive engine's speed sensors to wherein the electronic module detects changes in engine speed corresponding to throttle notch handle positions and having detected a speed change, the electronic module signals an air valve to open and discharge into an engine's intake manifolds.
